(19) United States
(12) Patent Application Publication
(10) Pub. No.: US 2017/0320267 A1
(43) Pub. Date: Nov. 9, 2017

(54) Variable Width Deposition for Additive Manufacturing with Orientable Nozzle

(71) Applicant: UT-Battelle, LLC, Oak Ridge, TN (US)

(72) Inventors: Randall F. Lind, Loudon, TN (US); Brian K. Post, Knoxville, TN (US); Lonnie J. Love, Knoxville, TN (US); Peter D. Lloyd, Knoxville, TN (US); Charles Lynn Carnal, Cookeville, TN (US); Craig A. Blue, Knoxville, TN (US); Vlastimil Kunc, Concord, TN (US)

(21) Appl. No.: 15/144,957

(22) Filed: May 3, 2016

(51) Int. Cl. B29C 64/209; B29C 47/00; B29L 31/00

(52) U.S. Cl. CPC B29C 64/209; B29C 47/0033; B29L 2031/00

(57) ABSTRACT

An additive manufacturing machine includes a nozzle assembly with a noncircular, rotatable outlet. The nozzle assembly deposits a bead of material having a width that is defined by the angular orientation of the noncircular shaped outlet with respect to the material deposition path direction. The combination of high material deposition rate and fine resolution save time and energy while also producing high-quality parts.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### CROSS-REFERENCE TO RELATED APPLICATIONS

None.

### THE NAMES OF THE PARTIES TO A JOINT RESEARCH AGREEMENT

None.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

None.

### STATEMENT REGARDING PRIOR DISCLOSURES BY THE INVENTOR OR A JOINT INVENTOR

None.

### BACKGROUND OF THE INVENTION

### 1. Field of the Invention

The present disclosure relates to additive manufacturing and more specifically to nozzle assemblies and methods for varying the width of a bead of material that is deposited with an additive manufacturing machine.

### 2. Description of the Related Art

Additive manufacturing, also known as 3D printing, is a process that is used to efficiently manufacture three-dimensional parts layer-by-layer. Unlike subtractive manufacturing processes, which require additional time and energy to remove excess material from an oversized piece of raw material, additive manufacturing selectively deposits raw material only where it is needed. Additive manufacturing is accomplished using polymers, metal alloys, resins, glasses or other materials that transition from a liquid or powder form to a solid form.

The Manufacturing Demonstration Facility (MDF) at the Oak Ridge National Laboratory (ORNL), in collaboration with CINCINNATI Incorporated, developed the Big Area Additive Manufacturing (BAAM) system, which extrudes thermoplastic pellets through a nozzle to build extremely large-scale parts. The BAAM system is capable of printing parts up to 20 feet long×8 feet wide×6 feet tall, depositing up to 100 pounds of material per hour, and is available from CINCINNATI Incorporated. The Additive Manufacturing Integrated Energy (AMIE) Demonstration Project, the 50th Anniversary COBRA vehicle, and the STRATI vehicle, were each made using the BAAM system. U.S. patent application Ser. No. 14/143,989, entitled “Method and Materials for Large Scale Polymer Additive Manufacturing”, filed on Dec. 30, 2013, describes the BAAM system in greater detail and is incorporated herein by reference.

While smaller-scale, desktop 3D printers produce parts having very high resolutions, they are only able to deposit a few grams of material per hour. As the nozzle area increases, the build speed increases, but the resolution decreases. As a consequence, the small voids and gaps that are present in parts produced on a desktop 3D printer are amplified on large-scale parts. Unfortunately, using a small-area nozzle on a large-scale 3D printer to improve resolution will dramatically increase the time and energy it takes to build parts such as a vehicle body, a boat hull or a dwelling.

What is needed is an additive manufacturing system that will optimize the deposit of material based on the requirements of the part being built.

### BRIEF SUMMARY OF THE INVENTION

Disclosed are several examples of an additive manufacturing machine and a nozzle assembly for depositing a bead of material having a variable width.

The following summary is provided to facilitate an understanding of some of the innovative features unique to the embodiments and is not intended to be a full description. A full appreciation of the various aspects of the embodiments disclosed can be gained by taking the enabling detailed description, claims, drawings, and abstract as a whole.

According to one example, a nozzle assembly for varying the width of a bead of material that is being deposited along a modified material deposition path with an additive manufacturing machine is disclosed. A stationary hollow member attaches the nozzle assembly to the additive manufacturing machine and extends about a central longitudinal axis and defines an inlet for accepting raw material and an outlet disposed downstream of the inlet. A rotatable hollow member extends about the central longitudinal axis and defines an inlet for accepting material from the outlet of the stationary hollow member and a downstream rotatable outlet that is noncircular shaped for depositing the bead of material from the nozzle. A driver rotates the rotatable hollow body about its longitudinal axis and in relation to the stationary hollow member so that the width of the bead of material that is deposited by the nozzle assembly is defined by the angular orientation of the noncircular shaped outlet with respect to the material deposition path direction as the nozzle assembly traverses along the material deposition path.

According to another example, a method for varying the width of a bead of material that is being deposited with an additive manufacturing machine comprises the steps of a) providing a nozzle assembly having a stationary hollow member for attaching the nozzle assembly to the additive manufacturing machine, the stationary hollow member extending about a central longitudinal axis and defining an inlet for accepting raw material and an outlet; a rotatable hollow member extending about the central longitudinal axis and defining an inlet for accepting material from the outlet of the stationary hollow member and a rotatable outlet that is noncircular shaped for depositing the bead of material from the nozzle; and a driver for rotating the rotatable hollow body about its longitudinal axis and in relation to said stationary hollow member; b) traversing the nozzle along a material deposition path with the additive manufacturing machine; and c) rotating the rotatable hollow member about its longitudinal axis and in relation to the stationary hollow member with the driver so that the width of the bead of material that is deposited by the nozzle assembly is defined by the angular orientation of the noncircular shaped outlet with respect to the material deposition path direction.

According to another example, an additive manufacturing machine includes a material delivery system. A nozzle assembly is disposed downstream of the material delivery system, the nozzle assembly having an outlet that is noncircular shaped and the width of a bead of material that is deposited by the outlet is defined by the angular orientation of the noncircular shaped outlet with respect to a material deposition path direction that the nozzle assembly is traversing.

### BRIEF DESCRIPTION OF THE SEVERAL VIEWS OF THE DRAWING(S)

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a top-view schematic representation of a single layer of a part made with a prior art nozzle.

FIG. 2 is a top-view schematic representation of a single layer of a part made with the nozzles and methods of the present disclosure.

FIG. 3 is a perspective view of a nozzle according to one example of the present disclosure.

FIG. 4 is a cross sectional illustration of a nozzle shown in a first position according to one example of the present disclosure and shown in a first position.

FIG. 5 is a cross sectional illustration of the exemplary nozzle of FIG. 4 shown in an alternate position.

FIG. 6 illustrates a top view of three, non-exhaustive examples of a noncircular nozzle outlet according to the present disclosure with the left-side and right-side views showing alternate angular orientations with respect to the material deposition paths.

FIG. 7 is a schematic representation of a series of method steps according to an example of the present disclosure.

### DETAILED DESCRIPTION OF THE INVENTION

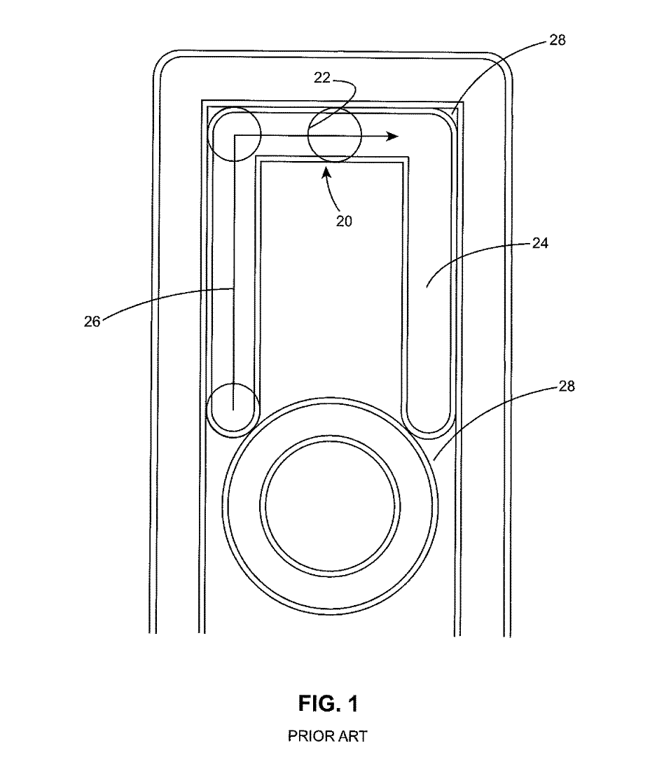

Referring first to FIG. 1, a prior art nozzle 20 has a circular shaped outlet 22 and deposits a bead 24 of material having a constant width and constant resolution along a deposition path 26 having a direction as indicated by the arrow. Note that voids and gaps 28 are present where features such as corners are formed and adjoining features meet. The voids and gaps 28 are formed when the required feature size is less than the diameter of the circular shaped outlet 22. A part having reduced strength and visual quality is the result of this prior art nozzle 20. While decreasing the diameter of the circular outlet 20 may actually improve the resolution, it will also negatively impact the time and energy required to build a large-scaled part.

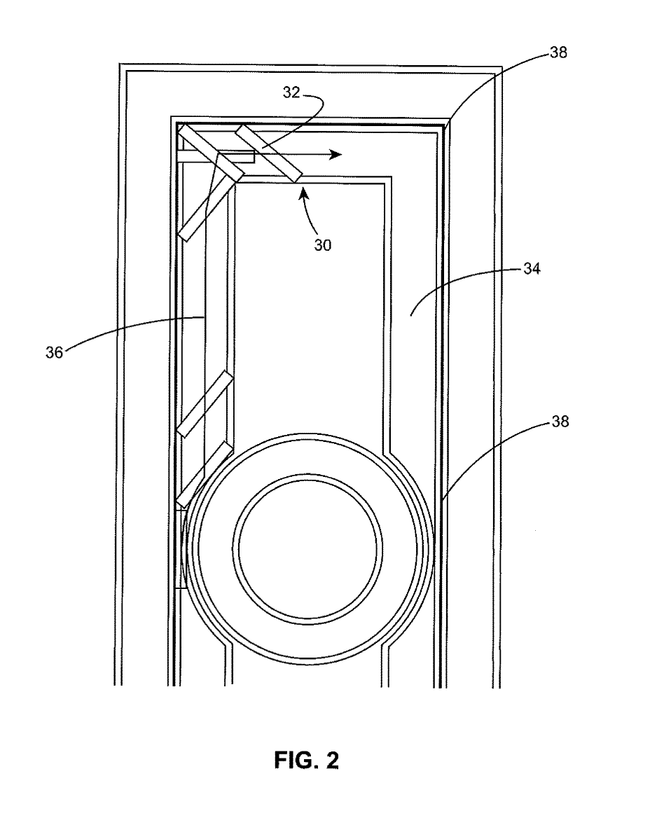

Referring now to FIG. 2, a nozzle assembly 30 having a noncircular shaped outlet 32 according to the present disclosure is shown depositing a bead 34 of material in several angular orientations with respect to a modified material deposition path 36 direction. Note that, while this particular example illustrates a rectangular shaped nozzle outlet 32, any shape that is noncircular (e.g., rectangle, square, ellipse, triangle, etc.) is contemplated and is within the scope of this disclosure. In the present example, the angular orientation of the nozzle outlet 32 varies as the nozzle deposits a variable width bead 34 of material along the modified material deposition path 36. Note that, in comparison to FIG. 1, the current voids or gaps 38 are either significantly reduced or completely eliminated. The disclosed nozzle assembly 30 provides for a rapid deposition of material in straight sections while also providing for a finer-resolution deposition in corners and where adjoining features meet, thus improving the quality of the part without sacrificing build speed.

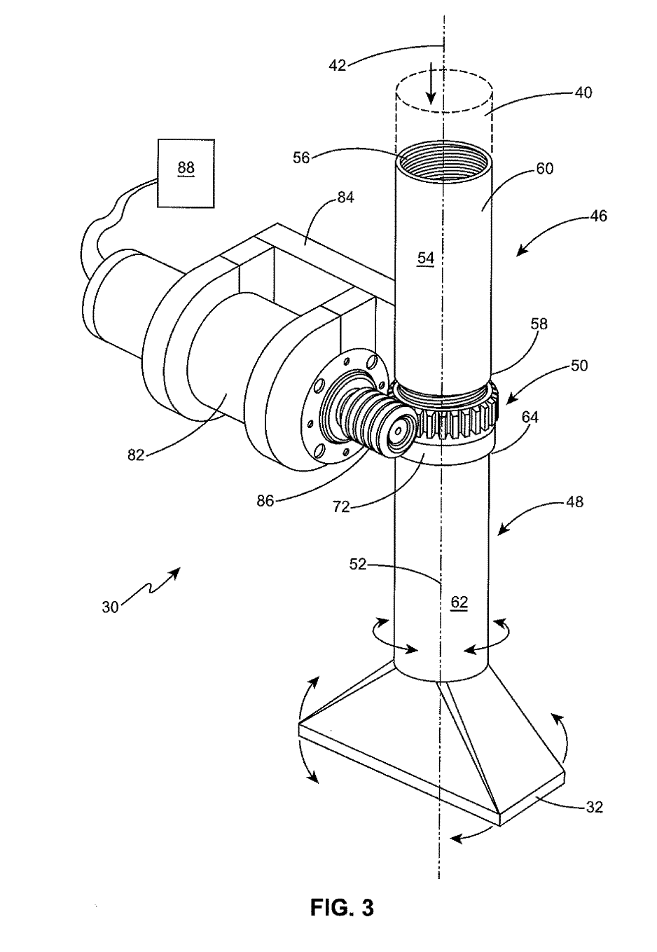

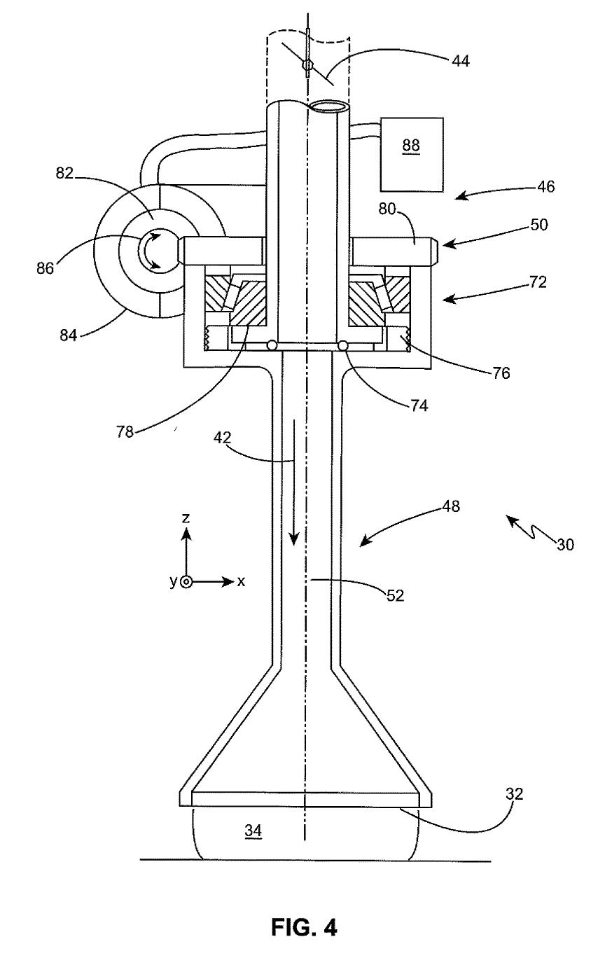

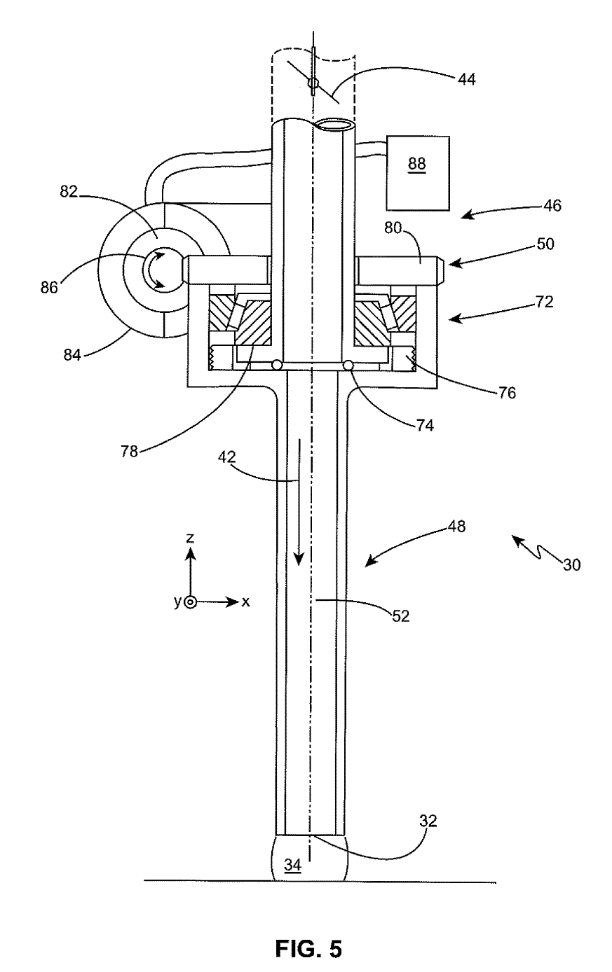

With reference now to FIGS. 3-6, examples of nozzle assemblies 30 for varying the width of a bead 34 of material that is being deposited with an additive manufacturing machine will now be described. A raw material delivery system 40 (shown in phantom) is part of the additive manufacturing machine and provides raw material to the nozzle assembly 30. The raw material delivery system 40 may include a single-screw or multi-screw extruder that delivers a molten thermoplastic polymer material 42 and/or a pump that delivers a liquid thermoset polymer material 42 for example. Other raw material delivery systems 40 are known and also contemplated. In some examples, a resistance or an inductive heating element heats the material 42 in the material delivery system 40 and/or the nozzle assembly 30. A valve 44 may modulate the flow of raw material 42 from the material delivery system 40 and can be fully open, partially open or completely shut as necessary. An example of a representative valve 44 is disclosed in U.S. patent application Ser. No. 14/852,188, entitled “Multi Orifice Deposition Nozzle for Additive Manufacturing”, filed on Sep. 11, 2015, and is incorporated herein by reference.

Extending from the raw material delivery system 40 is the nozzle assembly 30, which broadly includes a stationary hollow member 46, a rotatable hollow member 48 and a driver mechanism 50. The nozzle assembly 30 is made from materials having high strengths and good wear characteristics such as stainless steel for example.

The stationary hollow member 46 extends around a central longitudinal axis 52 and defines a stationary chamber 54 for accepting raw material 42 through a stationary inlet 56 and discharges the raw material 42 through a downstream, stationary outlet 58. The stationary hollow member 46 can be attached to the material delivery system 40 via engaged threads, a bolted flange, a cam lock, or some other attachment mechanism known in the art. The stationary chamber 54 may be cylindrical, conical or otherwise shaped and may converge or diverge in the material flow direction. An external surface 60 of the stationary hollow member 46 is generally cylindrical shaped. Note that the stationary hollow member 46 may be either a direct extension of, or a separate part of, the material delivery system 40 and does not rotate in relation to the material delivery system 40. However, the stationary hollow member 40 does move linearly along the X, Y or Z axes or within the X-Y, X-Z or Y-Z planes or within 3D space along with the material delivery system 40.

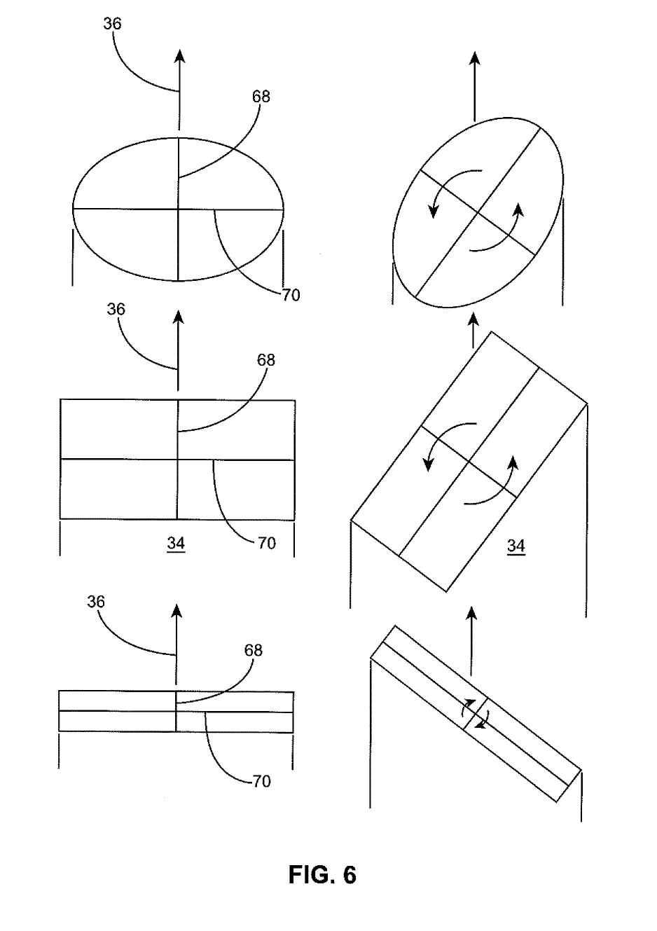

The rotatable hollow member 48 extends about the central longitudinal axis 52 and defines a rotatable chamber 62 that accepts raw material 42 from the stationary hollow member at a rotatable inlet 64 that is defined by the rotatable hollow member 48. The rotatable inlet 64 may be circular or noncircular shaped and may or may not match the size and shape of the stationary outlet 58. A rotatable, noncircular outlet 32 is defined by the rotatable hollow member 48 and is noncircular shaped (e.g., rectangle, square, ellipse, triangle, etc.). As illustrated best in FIG. 6, a rotatable outlet 32 that is noncircular shaped is defined by a minor width or axis 68 and a major width or axis 70. The aspect ratio of the major width or axis 70 over the minor width or axis 68 is greater than 1.0 for the rotatable outlet 32. Aspect ratios may be greater than 1.0, 2.0-3.0, or greater than 3.0 for example.

A connection or joint 72 between the stationary hollow member 46 and the rotatable hollow member 48 must rotate freely while also being adequately sealed to prevent leakage of material 42. In the example shown, an o-ring 74 and shaft seal 76 reduce leakage, and a tapered bearing 78 supports the rotatable hollow member 48 to ensure concentricity and freedom of rotational movement. Other joint 72 configuration details would similarly function in this application and are also contemplated.

The driver mechanism 50 rotates the rotatable hollow member 48 about the central longitudinal axis 52 and in relation to the stationary hollow member 46. In this example, a ring gear 80 is mounted to the rotatable hollow member 48 and a rotational device 82 is mounted to the stationary hollow member 46 via a stationary mounting flange 84. In this particular example, the rotational device 82 turns a pinion gear 86, which engages the ring gear 80 to impart relative motion. The rotational device 82 may be an electric motor, a pneumatic motor, a hydraulic motor, or a manual crank for example. In some rotational device 82 examples, a belt engages a pair of grooved pulleys. The rotational device 82 rotates the rotatable hollow member 48 and, in turn, positions the noncircular shaped nozzle outlet 32 based on electronic or mechanical commands, such as air or hydraulic pressure, provided by a controller 88.

In some examples, a three dimensional Computer Aided Design (CAD) model of the part is saved using an industry-standard, STL file format, for example. A slicer program then translates the STL file based on user input parameters and produces a new file containing individual layer definitions in machine code that the additive manufacturing machine uses for printing a physical part. The modified deposition path 36 and noncircular shaped outlet 32 angular orientation are used by the controller 88 to guide and orient the noncircular shaped outlet 32 along the modified deposition path 36 to provide for optimum resolution and minimum build time. In some examples, the modified nozzle deposition path 36 is in the X, Y or Z axes or within the X-Y, X-Z or Y-Z planes or within 3D space.

For the highest deposition rate, the controller 88 instructs the rotational device 82 to orient the noncircular shaped outlet 32 with its major width or axis 70 approximately perpendicular with, or ninety degrees to, the modified deposition path 36 direction. For a finer resolution at a lower deposition rate, the controller 88 instructs the rotational device 82 to orient the noncircular shaped outlet 32 with its minor width or axis 68 approximately parallel with, or zero degrees to, the modified deposition path 36 direction. Angular orientations between ninety degrees and zero degrees provide a compromise between deposition rate and resolution and helps reduce or eliminate voids or gaps 38. Note that the controller 88 also directs the position of the material delivery valve 44 and the nozzle assembly's 30 traverse speed to further optimize the part build.

A force sensing and load levelling platen may be used to level the bead of deposited material 34 to ensure a consistent layer thickness during all angular orientations of the noncircular outlet 32. One example of a load levelling platen is disclosed in U.S. patent application Ser. No. 14/517,571, entitled “Enhanced Additive Manufacturing with a Reciprocating Leveling and Force Sensing Platen”, filed on Oct. 17, 2014, which is incorporated herein by reference.

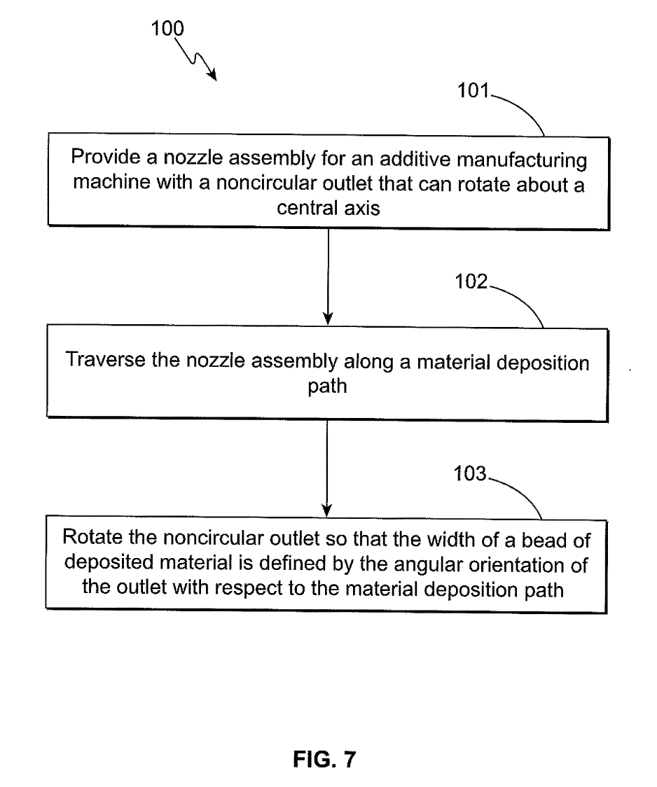

With reference finally to FIG. 7, an exemplary method 100 of the present disclosure will now be described. In a first step identified as 101, an additive manufacturing machine includes a nozzle assembly 30 having a stationary hollow member 46 for attaching the nozzle assembly 30 to a material delivery system 40 of the additive manufacturing machine. The stationary hollow member 46 extends about a central longitudinal axis 52 and defines an inlet 56 for accepting raw material 42 from a material delivery system 40 and an outlet 58. A rotatable hollow member extends 48 about the central longitudinal axis 52 and defines an inlet 64 for accepting material from the outlet 58 of the stationary hollow member 46 and a rotatable outlet 32 that is noncircular shaped for depositing the bead 34 of material from the nozzle assembly 30. A driver mechanism 50 for rotating the rotatable hollow member 48 about its longitudinal axis 52 and in relation to the stationary hollow member 46 so that the width of the bead of material 34 is controlled by the angular orientation of the noncircular shaped outlet 32. In a second step identified as 102, the nozzle assembly 30 is traversed along a modified material deposition path 36 by the additive manufacturing machine. In a third step identified as 103, the rotatable hollow member 48 is rotated with a driver 50 about its longitudinal axis 52 and in relation to the stationary hollow member 46 so that the width of the bead of material 34 that is deposited is defined by the angular orientation of the noncircular shaped outlet 32.

While this disclosure describes and enables several examples of an orientable nozzle assembly 30 for an additive manufacturing machine, other examples and applications are contemplated. Accordingly, the invention is intended to embrace those alternatives, modifications, equivalents, and variations as fall within the broad scope of the appended claims. The technology disclosed and claimed herein may be available for licensing exclusively or nonexclusively in specific fields of use by the assignee of record.

What is claimed is:

1) A nozzle assembly for varying the width of a bead of material that is being deposited along a modified material deposition path with an additive manufacturing machine comprising:
a stationary hollow member for attaching the nozzle assembly to a raw material delivery system of the additive manufacturing machine, said stationary hollow member extending about a central longitudinal axis and defining an inlet for accepting the raw material and an outlet disposed downstream of the inlet;
a rotatable hollow member extending about the central longitudinal axis and defining an inlet for accepting material from the outlet of said stationary hollow member and a downstream rotatable outlet that is noncircular shaped for depositing the bead of material from the nozzle; and
a driver for rotating said rotatable hollow body about its longitudinal axis and in relation to said stationary hollow member so that the width of the bead of material that is deposited is defined by the angular orientation of the noncircular shaped outlet with respect to the modified material deposition path direction as the nozzle assembly traverses along the modified material deposition path.

2) The nozzle assembly of claim 1 wherein the noncircular shaped outlet is rectangular shaped.

3) The nozzle assembly of claim 1 wherein the noncircular shaped outlet is oval shaped.

4) The nozzle assembly of claim 1 wherein said driver comprises:
a ring gear affixed to one of said hollow members;
a pinion gear extending from the other one of said hollow members by a shaft and meshing with said ring gear; and
a rotational device attached to the shaft.

5) The nozzle assembly of claim 4 wherein said rotational device is selected from the group consisting of an electric motor, a pneumatic motor, a hydraulic motor, and a hand crank.

6) The nozzle assembly of claim 1 and further comprising a controller and wherein said controller directs the driver to position the angular orientation of the noncircular shaped outlet.

7) The nozzle assembly of claim 1 and further comprising a sealing element disposed between said stationary hollow member and said rotational hollow member.

8) A method for varying the width of a bead of material that is being deposited with an additive manufacturing machine comprising the steps of:
a) providing a nozzle assembly having a stationary hollow member for attaching the nozzle assembly to a raw material delivery system of the additive manufacturing machine, said stationary hollow member extending about a central longitudinal axis and defining an inlet for accepting raw material and an outlet; a rotatable hollow member extending about the central longitudinal axis and defining an inlet for accepting material from the outlet of said stationary hollow member and a rotatable outlet that is noncircular shaped for depositing the bead of material from the nozzle; and a driver for rotating said rotatable hollow body about its longitudinal axis and in relation to said stationary hollow member;
b) traversing said nozzle along a modified material deposition path with the additive manufacturing machine; and
c) rotating said rotatable hollow member about its longitudinal axis and in relation to said stationary hollow member with said driver so that the width of the bead of material that is deposited by the nozzle assembly is defined by the angular orientation of the noncircular shaped outlet with respect to the modified material deposition path direction.

9) The method of claim 8 wherein the noncircular shaped outlet is rectangular shaped.

10) The method of claim 8 wherein the noncircular shaped outlet is oval shaped.

11) The method of claim 8 wherein said driver comprises:
a ring gear affixed to one of said hollow members;
a pinion gear extending from the other one of said hollow members by a rotatable shaft and meshing with said ring gear; and
a rotational device attached to the rotatable shaft.

12) The method of claim 11 wherein said rotational device is selected from the group consisting of an electric motor, a pneumatic motor, a hydraulic motor, and a hand crank.

13) The method of claim 8 and further comprising the step of:
d) directing the driver to position the angular orientation of the noncircular shaped outlet with a controller.

14) An additive manufacturing machine comprising:
a material delivery system;
a nozzle assembly disposed downstream of said material delivery system, said nozzle assembly having an outlet that is noncircular shaped and the width of a bead of material that is deposited by the outlet is defined by the angular orientation of the noncircular shaped outlet with respect to a modified material deposition path direction that the nozzle assembly is traversing.

15) The additive manufacturing machine of claim 14 wherein the noncircular shaped outlet is rectangular shaped.

16) The additive manufacturing machine of claim 14 wherein the noncircular shaped outlet is oval shaped.

17) The additive manufacturing machine of claim 14 and further comprising a controller and wherein said controller directs the angular orientation of the noncircular shaped outlet.
